(19) United States
(12) Patent Application Publication
(10) Pub. No.: US 2007/0164044 A1
(43) Pub. Date: Jul. 19, 2007

(54) APPARATUS AND CONTROL METHOD FOR SENSING TABLET IN TABLET PACKAGING MACHINE

(75) Inventor: Jun-ho Kim, Daegu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: JVM CO., LTD, Daegu (KR)

(21) Appl. No.: 11/623,594

(22) Filed: Jan. 16, 2007

Related U.S. Application Data
(63) Continuation-in-part of application No. 10/948,238, filed on Sep. 24, 2004, now abandoned.

(30) Foreign Application Priority Data
Sep. 25, 2003 (KR) 2003-66702

(51) Int. Cl. G07F 11/00

(52) U.S. Cl. 221/10

(57) ABSTRACT

A tablet sensing apparatus of an automatic tablet packaging machine includes a tablet cassette accommodating tablets and having a rotor, a motor to drive the rotor, an optical sensor unit sensing discharge of the tablets by detecting a level of voltage by a light receiving device from light emitted from a light emitting device, a light amount adjustment unit connected to the light emitting device to adjust the amount of light of the light emitting device, a passing time measuring unit connected to the light receiving device to measure a time when the tablets pass through the light receiving device from the inputted level of voltage, and a controller controlling the motor and the light amount adjustment unit to determine whether the tablets are abnormal or normal based on the passing time measured by the passing time measuring unit.

### CROSS REFERENCE TO RELATED APPLICATIONS

This application claims the benefit under 35 USC 120 to application Ser. No. 10/948,238 filed on Sep. 24, 2004. This application also claims the benefit of priority under 35 USC 119 to Korean Applications 2003-066702 filed on Sep. 25, 2003, the entire contents of which are hereby incorporated by reference.

### BACKGROUND OF THE INVENTION

1. Field of the Invention

The present invention relates to an automatic tablet packaging machine for discharging tablets from a tablet cassette and for packaging the tablets by a dose, and more particularly, to a tablet sensing apparatus of an automatic tablet packaging machine in which a sensing error of an optical sensor unit due to adhesion of foreign matter is prevented and damaged tablets are exactly sensed, and a control method thereof.

2. Description of the Related Art

In general, an automatic tablet packaging apparatus is an apparatus which automatically selects tablets prescribed based on the kind of disease of a patient to package the selected tablets for each dose. This apparatus includes a plurality of tablet cassettes containing various kinds of tablets and arranged on a frame. The plurality of tablet cassettes arranged on the frame are intermittently controlled such that tablets prescribed dose by dose are discharged to a hopper at a lower side of the frame though respective passages formed in the frame. Then, the discharged tablets collected in the hopper are packaged by packaging papers in an automatic tablet packaging apparatus.

In such an automatic tablet packaging apparatus, different kinds of tablets are accommodated in respective tablet cassettes arranged on the frame. The tablet cassettes are intermittently controlled, according to a prescription, such that the tablets accommodated in the tablet cassettes are discharged from the tablet cassettes.

FIG. 1 is a sectional view illustrating an example of configuration of a general tablet cassette showing tablet discharge.

As illustrated in the drawing, the automatic tablet packaging machine includes a tablet cassette 1, which includes a tablet container 1a, having an outlet 1b and mounted on a frame S with a discharging passage P, and a rotor 1c provided in the tablet container 1a, a motor 2, installed at the lower side of the tablet container 1a, to drive the rotor 1c, an optical sensor unit 3 installed in the outlet 1b and having a light emitting device 3a and light receiving device 3b, and a controller 4 to control the motor 2.

In the automatic tablet packaging machine, when the controller 4 drives the motor 2 based on the prescription inputted to the controller from the exterior, the rotor 1c coupled with the motor 2 rotates within the tablet container 1a to discharge the tablets one by one through the outlet 1b and the tablets passing through the outlet 1b fall down through the discharge passage P.

At that time, the optical sensor unit 3, installed in the outlet 1b, senses the tablets passing through the outlet 1b and inputs the sensed information to the controller 4.

The optical sensor unit 3 includes the light emitting device 3a and the light receiving device 3b, and senses a tablet passing through the outlet 1b when the tablet passes through a light that is emitted from the light emitting device 3a and is projected to the light receiving device 3b across the outlet 1b.

However, in the automatic tablet packaging machine, due to the property of the tablet in the form of a solid medicine made by making powdered medicine into a lump, the tablets collide with each other within the tablet cassette so that tablet dust is separated from the solid tablets, the tablet dust adheres to an external surface of the light receiving device, installed in the outlet, to deteriorate the photosensitivity of the light receiving device, and due to this, an error occurs when the optical sensor unit senses the discharged tablets.

For this reason, considering the deterioration of the photosensitivity due to the tablet dust, various methods of exactly discharging the tablets are proposed.

An example of these methods is disclosed in Korean Unexamined Patent Application Publication No. 2001-7013105. This Unexamnined Patent Application Publication discloses a method of sensing discharge of the tablets based on two reference values, i.e., a first reference value V1 and a second reference value V2, as shown in FIG. 2. More specifically, when a discharge signal of the tablets is inputted, a controller detects an output level of an optical signal of a light emitting device, sensed by a light receiving device, before the tablets are discharged, and sets the two reference values for the sensing of the tablets based on the output level of the optical signal.

The two reference values are set to the first reference value V1 and the second reference value V2, which are different from each other. The first reference value V1 is set to 90% of the output level of the optical signal and the second reference value V2 is set to 80% of the output level of the optical signal.

Accordingly, after the motor 2 is driven to discharge the tablets, when the output level of the optical signal of the light emitting device, sensed by the light receiving device, drops below the first reference value V1, it is determined when the tablets start to pass through the outlet, and when the output level of the optical signal is higher than the second reference value V2, it is determined that the tablets completely pass through the outlet. Thus, the discharge of the tablets is sensed.

Accordingly, even if the output level of the optical signal detected by the light receiving device is lowered due to contamination of the light receiving device, caused by the tablet dust, as shown in FIG. 3, the first reference value V1 and the second reference value V2 are reset to sense the discharge of the tablet in the contamination state before the tablets are discharged such that the precise sensing of the tablet discharge can be guaranteed.

However, in such a conventional sensing method of discharging tablets, only reference values for determining whether the tablets are discharged or not are varied without changing the optical signal for sensing the tablets before the tablets are discharged. Thus, since the photosensitivity of the light receiving device is significantly deteriorated even when the contamination caused by the tablet dust becomes slightly more serious, the sensing error of the discharge of the tablets frequently occurs.

Moreover, although broken or damaged tablets may be discharged through the outlet, the conventional tablet sensing method cannot precisely sense the broken or damaged tablets so that the automatic tablet packaging machine cannot precisely package the tablets by doses.

### SUMMARY OF THE INVENTION

Therefore, the present invention has been made in view of the above and/or other problems, and it is an aspect of the present invention to provide a tablet sensing apparatus of an automatic tablet packaging machine in which a sensing error of an optical sensor unit caused by adhesion of foreign matter is prevented and damaged tablets are precisely detected, and a control method thereof.

It is another aspect of the present invention to provide a tablet sensing apparatus of an automatic tablet packaging machine in which the amount of light is manually adjusted such that the amount of light of an optical sensor unit is easily adjusted.

It is another aspect of the present invention to provide a tablet sensing apparatus of an automatic tablet packaging machine in which the amount of light of an optical sensor unit is stably and precisely adjusted.

In accordance with the present invention, the above and other objects can be accomplished by the provision of a tablet sensing apparatus of an automatic tablet packaging machine comprising: a tablet cassette comprising a tablet container having a downwardly opened outlet and a rotor provided to rotate in the tablet container to discharge the tablets through the outlet one by one; a motor installed at the lower side of the tablet container to drive the rotor; an optical sensor unit installed in the outlet and comprising a light receiving device to detect a level of a voltage from a light emitted from a light emitting device for the detection of a discharge of the tablets; a light amount adjustment unit connected to the light emitting device to adjust the amount of light of the light emitting device; a passing time measuring unit connected to the light receiving device to measure a time when the tablets pass through the light receiving device from the level of a voltage; and a controller to control the motor while determining whether the tablets are discharged based on the level of a voltage inputted from the light receiving device, to estimate a change of the amount of light by comparing an initial level of a voltage detected by the light receiving device with a preset reference level of a voltage to control the light amount adjustment unit such that the estimated change of the amount of light is settled, and to determine whether the tablets are abnormal or normal by comparing a passing time of a tablet measured by the passing time measuring unit with a preset reference passing time.

The tablet sensing apparatus further comprises a pulse generator connected between the light amount adjustment unit and the light emitting device such that the amount of light emitted from the light emitting device is adjusted by a duty cycle of a pulse.

The tablet sensing apparatus further comprises a manual light amount adjustment unit connected to the pulse generator to manually adjust the amount of light emitted from the light emitting device.

In accordance with the present invention, the above and other objects can be accomplished by the provision of a tablet discharge sensing control method of an automatic tablet packaging machine comprising: operating a light emitting device installed in an outlet of a tablet cassette to emit light when a discharge signal is inputted according to a prescription and detecting an initial level of a voltage of a light receiving device from the light emitted from the light emitting device; determining a change of the amount of light by comparing the initial level of a voltage detected by the light receiving device with a preset reference level of a voltage; estimating the change of the amount of light when the amount of light is changed is determined and adjusting the amount of light of the light emitting device by as much as the change of the amount of light to settle the change of the amount of light of the light receiving device; discharging the tablets accommodated in the tablet cassette through the outlet by driving a motor of the tablet cassette, and detecting a level of a voltage of the light receiving device from the light emitted from the light emitting device to the light receiving device to sense the discharge of the tablet though the outlet; measuring a passing time when the tablets pass through the light receiving device based on the level of a voltage detected by the light receiving device; and determining whether the tablets passed through the outlet are abnormal or normal by comparing the measured passing time with a preset reference passing time.

The tablet discharge sensing control method further comprises outputting an error message to the exterior when it is determined that the tablets are abnormal after determining whether the tablets passed through the outlet are abnormal or normal.

### BRIEF DESCRIPTION OF THE DRAWINGS

These and/or other aspects and advantages of the present invention will become apparent and more readily appreciated from the following description of the embodiments, taken in conjunction with the accompanying drawings, in which:

FIG. 1 is a side sectional view illustrating a tablet cassette of a conventional automatic tablet packaging apparatus;

FIG. 2 is a graph illustrating a normal waveform of a sensing signal of an optical sensor unit of the conventional automatic tablet packaging machine;

FIG. 3 is a graph illustrating an abnormal waveform of a sensing signal of the optical sensor unit of the conventional automatic tablet packaging machine due to foreign matter;

FIG. 4 is a side sectional view illustrating a tablet cassette of an automatic tablet packaging machine according to an embodiment of the present invention;

FIG. 5 is a block diagram illustrating a tablet sensing apparatus of the automatic tablet packaging machine according to an embodiment of the present invention;

FIG. 6 is a graph illustrating a waveform of voltage when foreign matter is not adhered to a light receiving device of the tablet sensing apparatus according to the embodiment of the present invention;

FIG. 7 is a graph illustrating a waveform of voltage before adjusting the amount of light of a light emitting device of the tablet sensing apparatus according to the embodiment of the present invention;

FIG. 8 is a graph illustrating a waveform of voltage when foreign matter is adhered to the light receiving device of the tablet sensing apparatus according to the embodiment of the present invention;

FIG. 9 is a graph illustrating a waveform of voltage after adjusting the amount of light of a light emitting device of the tablet sensing apparatus according to the embodiment of the present invention; and

FIG. 10 is a flowchart illustrating a tablet sensing control method according to an embodiment of the present invention.

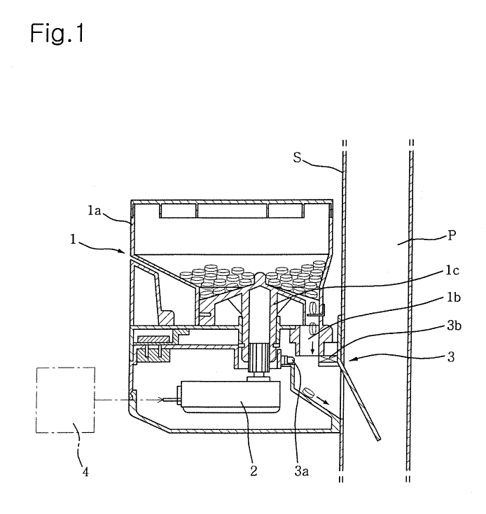

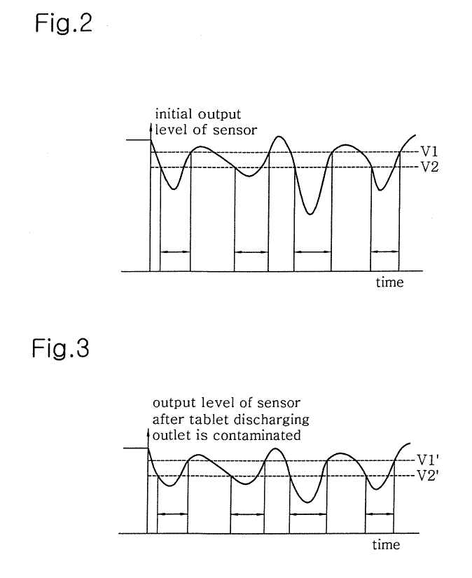

### DESCRIPTION OF THE PREFERRED EMBODIMENTS

Hereinafter, a tablet sensing apparatus of an automatic tablet packaging machine and a control method thereof according to embodiments of the present invention will be described in detail with reference to the accompanying drawings.

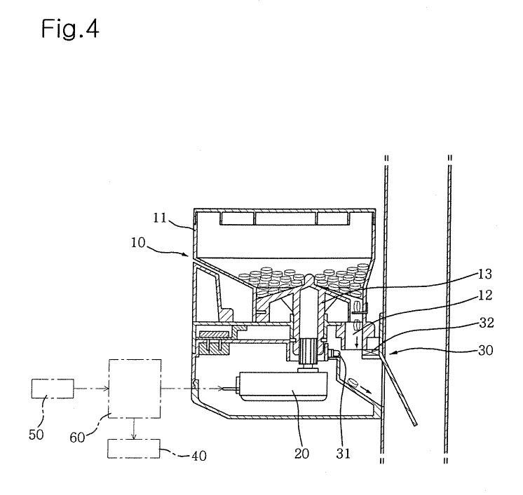

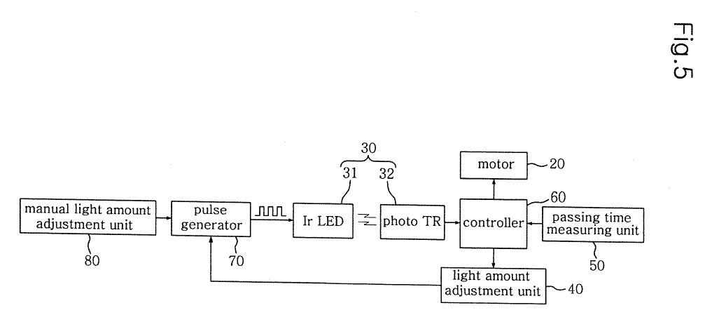

FIG. 4 is a side sectional view illustrating a tablet cassette of an automatic tablet packaging machine according to an embodiment of the present invention, and FIG. 5 is a block diagram illustrating a tablet sensing apparatus of the automatic tablet packaging machine according to an embodiment of the present invention.

As illustrated in the drawings, the tablet sensing apparatus of an automatic tablet packaging machine according to an embodiment of the present invention includes a tablet cassette 10 to accommodate tablets, a motor 20 as a driving device to discharge the tablets accommodated in the tablet cassette 10, an optical sensor unit 30 to sense the tablets discharged from the tablet cassette 10, a light amount adjustment unit 40 to adjust the amount of light emitted from the optical sensor unit 30, a passing time measuring unit 50 to measure a passing time of the tablets passing through the optical sensor unit 30, and a controller 60 to control the discharge of the tablets based on a tablet discharging signal inputted according to a prescription.

The tablet cassette 10 includes a tablet container 11 having a downwardly opened outlet 12 and a rotor 13 provided to rotate in the tablet container 11 to discharge the tablets through the outlet 12 one by one.

The tablet container 11 contains a plurality of tablets, the outlet 12 is a passage through which the tablets are discharged from the tablet container 11, and the rotor 13 is rotated by the motor 20 such that the tablets in the tablet container 11 are separated from the rest and discharged through the outlet 12 one by one.

The motor is installed at the lower side of the tablet container 11 and is controlled by a driving signal of the controller 60 to drive the rotor 13.

The optical sensor unit 30 includes alight emitting device 31 installed in the outlet 12 to emit light and a light receiving device 32 to receive the light emitted from the light emitting device 31 to detect a level of a sensed voltage. When the tablets pass through the outlet 12 to partially intercept the light projected to the light receiving device 32, and due to this, a level of the voltage detected by the light receiving device 32 is changed, the optical sensor unit 30 senses the discharge of the tablets based on the changed level of the voltage.

The light amount adjustment unit 40 is connected to the light emitting device 31 and controlled by the controller 60 to adjust the amount of light emitted from the light emitting device 31.

The passing time measuring unit 50 is connected to the light receiving device 32, measures time when the tablets pass through the light receiving device 32 based on the level of the voltage inputted from the light receiving device 32, and inputs the measured time to the controller 60.

The controller 60 determines whether the tablets pass through the light receiving device 32 based on the level of the voltage inputted from the light receiving device 32 and controls the motor 20. The controller 60 compares an initial level of a voltage detected by the light receiving device 32 with a preset reference level of a voltage to estimate a change of the amount of light and controls the light amount adjustment unit 40 such that the estimated change of the amount of light is settled. The controller 60 determines whether the tablets are normal or abnormal by comparing the passing time of the tablets measured by the passing time measuring unit 50 with a preset reference passing time.

When the tablet dust adheres to the light receiving device 32 and due to this the optical reception is lowered, namely, the amount of light is changed, the controller 60 controls the light amount adjustment unit 40 to increase the amount of light of the light emitting device 31 such that the optical reception of the light receiving device 32 is increased to settle the light amount difference. Due to this, the sensing error of the optical sensor unit 30 caused by the difference between the amounts of light is prevented.

The controller 60 detects whether the tablets are normal or abnormal by comparing the passing times inputted from the passing time measuring unit 50. For example, if it is determined that a tablet passed through for a time shorter than a preset passing time, since this is a case that the tablet is shortened, in other words, the tablet is broken, the controller 60 detects the tablet is abnormal and transmits a tablet abnormality signal to the exterior.

The tablet sensing apparatus further includes a pulse generator 70 connected between the light amount adjustment unit 40 and the light emitting device 31. The amount of light emitted from the light emitting device 31 is adjusted by a duty cycle of a pulse generated by the pulse generator 70.

The tablet sensing apparatus further includes a manual light amount adjustment unit 80 connected to the pulse generator 70. Due to the manual light amount adjustment unit 80, a user can adjust the amount of light from the light emitting device 31 manually.

In this case, when the duty cycle of the pulse generated from the pulse generator 70 is adjusted by the manual light amount adjustment unit 80 periodically or whenever the user needs, the amount of light emitted from the light emitting device 31 is adjusted so that the intensity of light received by the light receiving device 32 can be directly and manually adjusted.

In the tablet sensing apparatus as constructed above, the amount of light received by the light receiving device 32 is detected before the tablets are discharged. When the detected amount of light is different from the reference amount of light, it is determined that the difference is generated due to the tablet dust The amount of light emitted from the light emitting device 31 is compensated by as much as the difference of the amount of light by the light amount adjustment unit 4050 that the discharge of the tablets can be precisely detected.

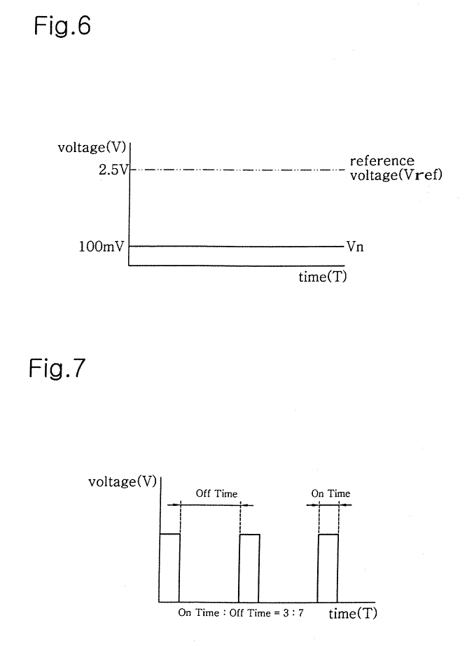

FIG. 6 is a graph illustrating a waveform of a voltage when foreign matter is not adhered to the light receiving device of the tablet sensing apparatus according to the embodiment of the present invention, and FIG. 7 is a graph illustrating a waveform of a voltage before adjusting the amount of light of the light emitting device of the tablet sensing apparatus according to the embodiment of the present invention.

FIG. 6 illustrates preset reference voltages of the light receiving device such as a reference level of a voltage Vref used to detect whether the tablets are discharged and an initial level of a voltage Vn used to adjust the amount of light.

When the tablets are discharged through the outlet and intercept the light projected from the light emitting device to the light receiving device, a level of a voltage of the light receiving device is increased. In this case, when the detected level of a voltage of the light receiving device is greater than the reference level of a voltage Vref, namely, 2.5 V, it is determined that the tablets are discharged.

Here, the initial level of a voltage Vn indicates a level of a voltage of the light receiving device at the most idealized initial state and a level of a voltage, basically applied from the pulse generator to the light emitting device, is illustrated in FIG. 7.

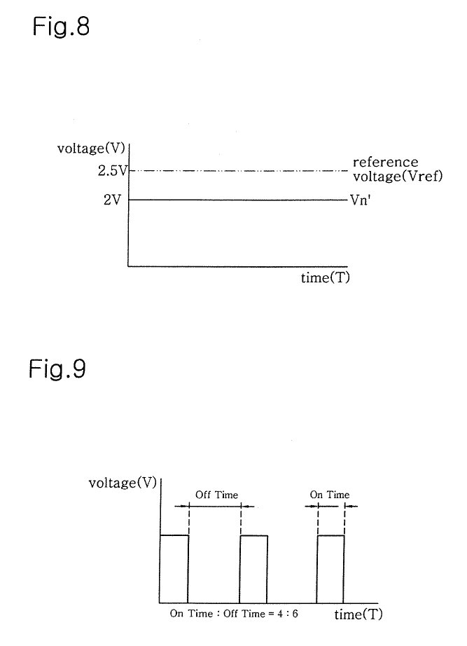

FIG. 8 is a graph illustrating a waveform of a voltage when foreign matter is adhered to the light receiving device of the tablet sensing apparatus according to the embodiment of the present invention, and

FIG. 9 is a graph illustrating a waveform of a voltage after adjusting the amount of light of the light emitting device of the tablet sensing apparatus according to the embodiment of the present invention.

As illustrated in the drawings, the initial level of a voltage of the light receiving device is inversely proportional to ON-Time of the light emitting device. In other words, as the intensity of light emitted from the light emitting device is increased (as the ON-Time is longer), the initial level of a voltage of the light receiving device Vn is decreased.

Thus, when dust or the tablet dust adheres to the surfaces of the light emitting device and the light receiving device, namely, when the intensity of light is decreased due to the tablet dust, an abnormal initial level of a voltage Vn′ is measured as illustrated in FIG. 8. As the intensity of light is seriously decreased due to the tablet dust, the abnormal initial level of a voltage Vn′ is continuously increased.

As such, when the abnormal initial level of a voltage Vn′ is increased higher than the reference level of a voltage Vref used to determine whether the tablets are discharged or not, in spite that the tablets have not yet been discharged, it is determined that the tablets have lady been discharged and a detecting error occurs.

Accordingly, in the tablet sensing apparatus of the present invention, in order to prevent the detecting error, when the initial level of a voltage Vn of the light receiving device 32 is measured before the tablets are discharged and the abnormal initial level of a voltage Vn′ higher than the initial reference level of a voltage of 100 mV is measured as shown in FIG. 8, a period of the ON-Time of the light emitting device 31 is increased as shown in FIG. 9 so that the abnormal initial level of a voltage Vn′ is changed to the normal initial level of a voltage Vn and the tablets are discharged. By doing so, the discharge of the tablets is detected in a normal manner.

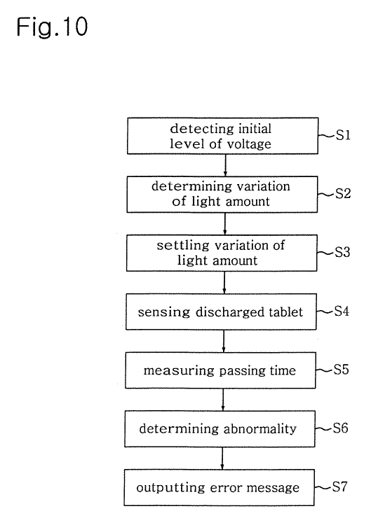

FIG. 10 is a flowchart illustrating a tablet sensing control method according to an embodiment of the present invention

As shown in the drawing, the tablet sensing method of an automatic tablet packaging machine includes an initial voltage level detecting operation S1 of operating the light emitting device 31 and the light receiving device 32 before the tablets are discharged to detect the initial level of a voltage using the light receiving device, a light amount change determining operation S2 of determining a change of the amount of light based on the detected initial level of a voltage, a light amount change settling operation S3 of settling the change of the amount of light, a tablet discharge sensing operation S4 of sensing the tablet after discharging the tablet, a passing time measuring operation S5 of measuring a time when the tablet passes through the light receiving device, and an abnormality determined operation S6 of determining whether the tablet is abnormal or not based on the passing time. The above operations are carried out in sequence so that a state of discharging the tablets is precisely sensed.

In the initial voltage level detecting operation S1, when a discharging signal of the tablets is inputted according to the prescription, the light emitting device, installed in the outlet of the tablet cassette, is operated to emit light before discharging the tablets and the light receiving device 32 detects the initial level of a voltage from the light emitted from the light emitting device 31.

In other words, the initial voltage level detecting operation S1 is an operation of detecting a level of an optical signal of the light receiving device 32, namely, the initial level of a voltage of the light receiving device 32 before discharging the tablets.

In the light amount change determining operation S2, the initial level of a voltage detected by the light receiving device 32 is compared with the preset reference level of a voltage to determine the change of the amount of light.

The reference level of a voltage indicates a level of a voltage of the light receiving device 32 in an initial state without adhered tablet dust and is preset in the controller 60.

In the light amount change determining operation S2, the initial level of a voltage of the light receiving device 32 detected before discharging the tablets is compared with the preset reference level of a voltage in the controller 60 to determine whether the amount of light of the light receiving device is changed due to the tablet dust or not.

In the light amount change settling operation S3, when the changed amount of light is determined by the comparison of the initial level of a voltage, the changed amount of light is estimated and the amount of light of the light emitting device is adjusted by as much as the changed amount of light to settle the change of the amount of light of the light receiving device.

In other words, in the light amount change settling operation S3, when the amount of light is changed, namely, the amount of light is decreased due to the tablet dust the amount of light of the light emitting device 31 is increased such that the amount of light determined by the light receiving device becomes the initial level of a voltage to settle the change of the amount of light due to the tablet dust.

In the tablet discharge sensing operation S4, the motor 20 of the tablet cassette is driven after settling the change of the amount of light, the tablets accommodated in the tablet cassette are discharged through the outlet, and the light receiving device detects the level of a voltage from the light emitted from the light emitting device to the light receiving device to sense the tablet discharged through the outlet.

In other words, in the tablet discharge sensing operation S4, the change of the amount of light is settled, the discharge of the tablets is carried out, and the discharge of the tablets is sensed.

In the passing time measuring operation S5, the time when the tablets pass through the light receiving device 32 is measured based on the level of a voltage detected by the light receiving device 32. The passing time of the tablets corresponds to a period where the level of a voltage of the light receiving device 32 is suddenly increased, namely, a time of maintaining a period when the level of voltage is formed, and the time is measured to estimate the passing time of the tablets.

In the abnormality determined operation S6, the measured passing time is compared with a preset reference passing time to determine whether the tablet passed through the outlet is abnormal or normal.

The reference passing time is a time when the tablets pass through the light receiving device 32 in a normal manner and is preset in the controller 60.

When the measured passing time is shorter than the reference passing time as a result of comparing the measured passing time with the reference passing time, since this means that the tablet is broken and its length is shortened, the abnormality of the tablet is determined.

The control method according to the present invention further includes an error message outputting operation S7 of outputting an error message to the exterior when it is determined that the tablet is abnormal, after the abnormality determined operation S6. In the error message outputting operation S7, when it is determined that the tablet is abnormal, namely, that the tablet is broken, the error message is outputted to the exterior such that the user can perceive that a broken tablet or a damaged tablet is discharged.

As described above, according to the present invention, the sensing error of the optical sensor unit caused by adhered foreign matter is clearly prevented, the broken tablets or the damaged tablets are securely sensed, and the tablets are steadily and precisely discharged from the tablet cassette.

According to the present invention, the amount of light of the optical sensor unit is easily adjusted by manually adjusting the amount of light and the convenience of using the optical sensor unit is increased.

Moreover, the amount of light of the optical sensor unit is steadily and precisely adjusted so that light is stably emitted by the optical sensor unit

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A tablet sensing apparatus of an automatic tablet packaging machine comprising:
a tablet cassette comprising a tablet container having a downwardly opened outlet and a rotor provided to rotate in the tablet container to discharge the tablets through the outlet one by one;
a motor installed at the lower side of the tablet container to drive the rotor;
an optical sensor unit installed in the outlet and comprising a light receiving device to detect a level of a voltage from a light emitted from a light emitting device for the detection of a discharge of the tablets;
a light amount adjustment unit connected to the light emitting device to adjust the amount of light of the light emitting device;
a passing time measuring unit connected to the light receiving device to measure a time when the tablets pass through the light receiving device from the level of a voltage; and
a controller to control the motor while determining whether the tablets are discharged based on the level of a voltage inputted from the light receiving device, to estimate a change of the amount of light by comparing an initial level of a voltage detected by the light receiving device with a preset reference level of a voltage to control the light amount adjustment unit such that the estimated change of the amount of light is settled, and to determine whether the tablets are abnormal or normal by comparing a passing time of a tablet measured by the passing time measuring unit with a preset reference passing time.

2. The tablet sensing apparatus according to claim 1, further comprising a pulse generator connected between the light amount adjustment unit and the light emitting device such that the amount of light emitted from the light emitting device is adjusted by a duty cycle of a pulse.

3. The tablet sensing apparatus according to claim 2, further comprising a manual light amount adjustment unit connected to the pulse generator to manually adjust the amount of light emitted from the light emitting device.

4. A tablet discharge sensing control method of an automatic tablet packaging machine comprising:
operating a light emitting device installed in an outlet of a tablet cassette to emit light when a discharge signal is inputted according to a prescription and detecting an initial level of a voltage of a light receiving device from the light emitted from the light emitting device;
determining a change of the amount of light by comparing the initial level of a voltage detected by the light receiving device with a preset reference level of a voltage;
estimating the change of the amount of light when the amount of light is changed is determined and adjusting the amount of light of the light emitting device by as much as the change of the amount of light to settle the change of the amount of light of the light receiving device;
discharging the tablets accommodated in the tablet cassette through the outlet by driving a motor of the tablet cassette, and detecting a level of a voltage of the light receiving device from the light emitted from the light emitting device to the light receiving device to sense the discharge of the tablet through the outlet;
measuring a passing time when the tablets pass through the light receiving device based on the level of a voltage detected by the light receiving device; and
determining whether the tablets passed through the outlet are abnormal or normal by comparing the measured passing time with a preset reference passing time.

5. The tablet discharge sensing control method according to claim 4, further comprising outputting an error message to the exterior when it is determined that the tablets are abnormal after determining whether the tablets passed through the outlet are abnormal or normal.
